(19) United States
(12) Patent Application Publication
(10) Pub. No.: US 2026/0099269 A1
(43) Pub. Date: Apr. 9, 2026

(54) PRINTING HEAD AND DATA RECOGNITION METHOD

(71) Applicant: CANON KABUSHIKI KAISHA, Tokyo (JP)

(72) Inventor: MASAO FURUKAWA, Kanagawa (JP)

(21) Appl. No.: 19/348,594

(22) Filed: Oct. 2, 2025

(30) Foreign Application Priority Data
Oct. 8, 2024 (JP) 2024-176464

(51) Int. Cl. G06F 3/06

(52) U.S. Cl. CPC G06F 3/0655; G06F 3/0604; G06F 3/0673

(57) ABSTRACT

A printing head includes a memory unit configured with use of one of fuse elements or antifuse elements. The memory unit includes a main memory circuit configured to store a fixed value related to the printing head, and a correction value memory circuit configured to store a correction value for updating the fixed value.

### BACKGROUND

### Field of the Technology

The present disclosure relates to a printing head including a memory that is configured with use of a fuse element or an antifuse element, and to a data recognition method.

### Description of the Related Art

In some of recent printing heads, a one-time programmable (OTP) memory is mounted in order to store, after the product is completed, information unique to the product such as a serial number and a parameter for driving the printing head. Memories that use a fuse element or an antifuse element are known as the OTP memory. In Japanese Patent Laid-Open No. 2014-58130, there is described a printing head including a memory that uses an antifuse element. When the printing head is manufactured, a drive condition of the head is stored in the memory as information unique to the printing head (a fixed value).

In Japanese Patent No. 3537899, there is described, as a technology related to the OTP memory, an electrical circuit in which a fuse element and an antifuse element are combined so that one bit of information (binary information) is rewritable a plurality of number of times.

In the printing head as described in Japanese Patent Laid-Open No. 2014-58130, information cannot be rewritten in the memory that uses an antifuse element and, consequently, the fixed value (for example, a drive condition of the head) stored in the memory cannot be updated. Accordingly, when, for example, the drive condition of the head changes, performance of the printing head may deteriorate. The deterioration in performance of the printing head can be suppressed by separately providing an OTP memory for storing an updated fixed value. In this case, however, a problem in that the addition of the OTP memory increases memory capacity arises.

The fixed value can be updated by using, as the memory for storing the fixed value, the rewritable memory circuit as described in Japanese Patent No. 3537899. In this case, however, the circuit is complicated and an area required to form the memory increases. A resultant problem is an increase in size of the printing head.

### SUMMARY

The present disclosure is directed to providing a printing head that allows for updating of a fixed value and, at the same time, prevents memory capacity and head size from increasing.

According to one aspect of the present disclosure, there is provided a printing head including a memory unit configured with use of one of fuse elements or antifuse elements, the memory unit including: a main memory circuit configured to store a fixed value related to the printing head; and at least one correction value memory circuit configured to store a correction value for updating the fixed value.

Features of the present disclosure will become apparent from the following description of embodiments with reference to the attached drawings. The following description of embodiments is described by way of example.

### BRIEF DESCRIPTION OF THE DRAWINGS

FIG. 1 is a perspective view for illustrating a schematic configuration of a printing apparatus to which a printing head of the present disclosure is mountable.

FIG. 2 is a perspective view of the printing head mounted to the printing apparatus illustrated in FIG. 1.

FIG. 3 is a schematic diagram for illustrating a printing head according to a first embodiment of the present disclosure.

FIG. 4A is a schematic diagram for illustrating an example of a memory circuit which stores a fixed value.

FIG. 4B is a schematic diagram for illustrating another example of the memory circuit which stores the fixed value.

FIG. 5 is a schematic diagram for illustrating a state of the memory circuit in which a rank value has been written.

FIG. 6A is a flow chart for illustrating an example of data recognition processing.

FIG. 6B is a flow chart for illustrating the example of the data recognition processing.

FIG. 7A is a schematic diagram for illustrating a state of one correction value memory circuit at a time of first reuse.

FIG. 7B is a schematic diagram for illustrating a state of another correction value memory circuit at a time of first reuse.

FIG. 8A is a schematic diagram for illustrating the state of the one correction value memory circuit at a time of second reuse.

FIG. 8B is a schematic diagram for illustrating the state of the another correction value memory circuit at a time of second reuse.

FIG. 9 is a schematic diagram for illustrating an example of a memory circuit that stores a density rank value.

FIG. 10A is a schematic diagram for illustrating an example of one memory circuit that stores a correction value of the density rank value.

FIG. 10B is a schematic diagram for illustrating an example of another memory circuit that stores a correction value of the density rank value.

FIG. 11 is a schematic diagram for illustrating a printing head according to a third embodiment of the present disclosure.

FIG. 12A is a schematic diagram for illustrating an example of still another correction value memory circuit.

FIG. 12B is a schematic diagram for illustrating the example of the still another correction value memory circuit.

FIG. 13 is a flow chart for illustrating an example of data recognition processing.

FIG. 14 is a schematic diagram for illustrating a printing head according to a fourth embodiment of the present disclosure.

FIG. 15A is a schematic diagram for illustrating an example of yet still another correction value memory circuit.

FIG. 15B is a schematic diagram for illustrating an example of yet still another correction value memory circuit.

FIG. 16 is a schematic diagram for illustrating a state of the yet still another correction value memory circuit at a time of second reuse.

FIG. 17 is a flow chart for illustrating another example of the data recognition processing.

### DESCRIPTION OF THE EMBODIMENTS

Embodiments of the present disclosure are described below in detail with reference to the drawings. However, the embodiments are merely exemplification, and are not intended to limit a scope of the present disclosure thereto. In the drawings, components having the same function are denoted by the same reference symbols, and description thereof may be omitted.

### First Embodiment

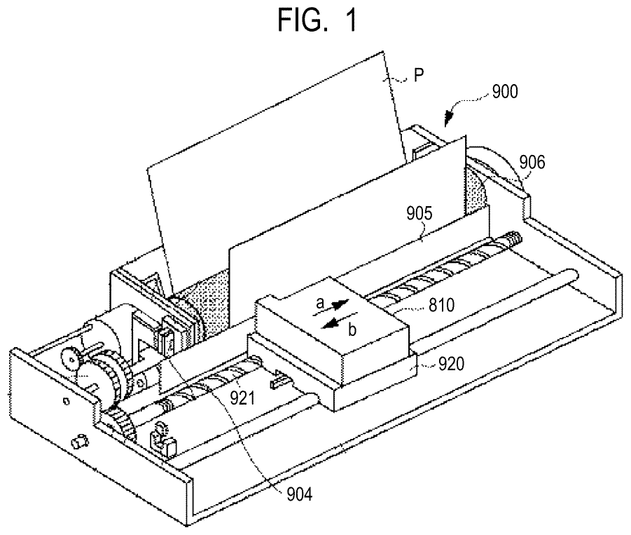

FIG. 1 is a perspective view for illustrating a schematic configuration of a printing apparatus in which a printing head according to the present disclosure is mountable. A printing apparatus 900 includes a printing control unit (not shown). The printing control unit controls operation of respective components of the printing apparatus 900 in accordance with an electrical signal of printing data or the like from an outside. The printing apparatus 900 includes, as a component, a printing head 810 which ejects a liquid such as ink. The printing head 810 prints by, for example, an ink jet method. The printing head 810 is mounted on a carriage 920. The carriage 920 is attached to a lead screw 904 which has a helical groove 921. Rotation of the lead screw 904 enables the printing head 810 to move in a direction of an arrow “a” or an arrow “b” together with the carriage 920. A carriage substrate (not shown) for electrical connection to a contact pad of the printing head 810 which is described later is mounted to the carriage 920. A recording sheet P is conveyed onto a platen 906 by a sheet conveyance unit (not shown). A sheet pressing plate 905 presses the recording sheet P to the platen 906 along a carriage moving direction. Printing to the recording sheet P is performed by repeating a reciprocal movement of the printing head 810 and conveyance of the recording sheet P.

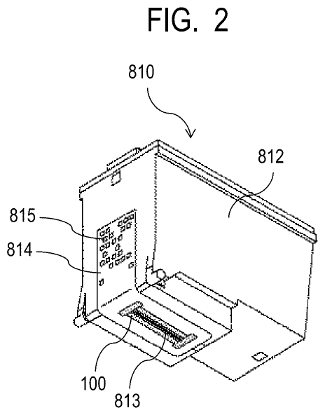

FIG. 2 is a perspective view of the printing head 810 mounted to the printing apparatus 900 illustrated in FIG. 1. A plurality of ejection ports 813 from which the liquid is ejected are formed in a row in an element substrate 100. Various circuits (not shown) including an energy generation element (hereinafter also referred to as “heater”) for generating an ejection energy which is used to eject the liquid from the ejection ports are formed on the element substrate 100. The element substrate 100 establishes electrical conduction to a contact pad 815 for electrically connecting to the printing apparatus 900 via a flexible film wiring board 814.

The printing head 810 includes an ink tank 812. The ink tank 812 includes an ink holding member (not shown) which is, for example, fibrous or porous, and uses the ink holding member to hold ink. The printing head 810 receives, at the contact pad 815, an electrical signal from a carriage substrate mounted to the carriage 920, and ejects the ink in accordance with the electrical signal. The printing head 810 illustrated in FIG. 2 has a configuration in which the element substrate 100 and the ink tank 812 are integrated into one, but may have a configuration that allows the ink tank to be separated.

In order to eject the ink from the ejection ports 813, the heater is required to be energized. However, because of an individual difference of the element substrate 100, energy optimum for the ejection varies from one element substrate 100 to another element substrate 100. For adjustment of this ejection energy, two parameters which are a voltage applied to the heater and duration of energization of the heater are used. In the printing apparatus 900, the voltage applied to the heater is kept constant and the duration of the energization is adjusted. However, the duration of the energization is relatively short, and is accordingly preferred to be managed by a pulse width of an electrical signal. This pulse width is hereinafter referred to as “drive pulse width.” A method in which the applied voltage is adjusted with the duration of the energization kept constant, or a method in which the applied voltage and the duration of the energization are both adjusted may also be applied.

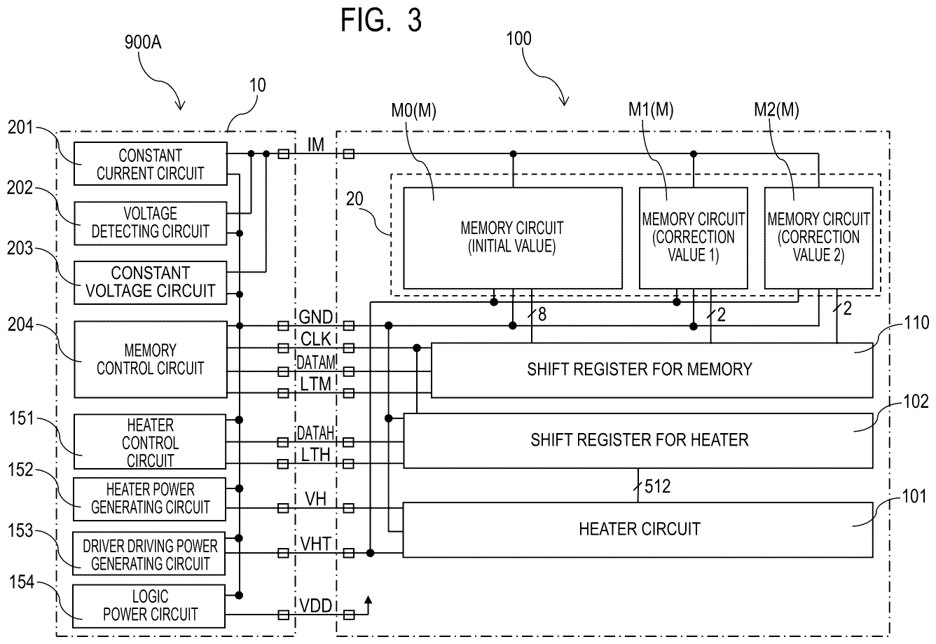

FIG. 3 is a schematic diagram for illustrating a configuration of the printing head 810 according to a first embodiment of the present disclosure. In FIG. 3, electrical connection between a main-body portion 900a of the printing apparatus 900 and the element substrate 100 of the printing head 810 is schematically illustrated. The main-body portion 900a of the printing apparatus 900 includes a control unit 10. The control unit 10 includes a constant current circuit 201, a voltage detecting circuit 202, a constant voltage circuit 203, a memory control circuit 204, a heater control circuit 151, a heater power generating circuit 152, a driver driving power generating circuit 153, and a logic power circuit 154. Details of those circuits are described later.

The element substrate 100 includes a memory unit 20, a heater circuit 101, a shift register 102 for heater, and a shift register 110 for memory. The memory unit 20 is configured with use of a fuse element or an antifuse element, and includes a memory circuit (initial value) M0, a memory circuit (correction value 1) M1, and a memory circuit (correction value 2) M2. The memory circuit M0 can be called “main memory circuit.” The memory circuits M1 and M2 can each be called “correction value memory circuit.” In the heater circuit 101, a pair of a heater and a driver (heater driver) (not shown) is formed so as to correspond to each of the ejection ports 813. In this embodiment, the number of ejection ports 813 is 512, and the number of pairs of the heater and the heater driver is 512.

The shift register 102 for heater is configured so as to select a heater to be energized out of heaters in the heater circuit 101. The heater control circuit 151 outputs a data signal DATAH to the shift register 102 for heater so that a desired heater is energized. This data signal DATAH is in synchronization with a timing signal CLK. As the timing signal CLK, the same signal as a signal of the memory control circuit 204 described later is used. After data output to the shift register 102 for heater to energize a desired heater is completed, a latch signal LTH for keeping that data is turned on to switch operation of each heater driver.

The heater circuit 101 has, other than the signal input from the shift register 102 for heater, two systems of input related to power. One is a heater power VH, and another is a driver power VHT. The heater power generating circuit 152 generates the heater power VH, and the driver driving power generating circuit 153 generates the driver power VHT. The operation of one heater driver is switched with the use of the latch signal LTH, and the driver power VHT is supplied to that heater driver. In this embodiment, the driver power VHT is 5 volts. The heater power VH for a current that flows when one heater is energized is 24 volts. The logic power circuit 154 supplies a power VDD to every logic element formed on the element substrate 100. In this embodiment, the power VDD is 3.3 volts.

The shift register 110 for memory is an element for switching data for turning, on and off, a transistor that is put into operation when data is written to one of the memory circuits M0 to M2 and when data is read out of one of the memory circuits M0 to M2. Details of the shift register 110 for memory are described later.

The memory circuit M0 is for storing information (a fixed value) unique to the printing head 810. The memory circuit M1 and the memory circuit M2 are used when the fixed value is updated, and each store a correction value for updating the fixed value. Each of the memory circuits M0 to M2 is constructed from an OPT memory using a fuse element or an antifuse element. A memory capacity of each of the memory circuits M1 and M2 is smaller than a memory capacity of the memory circuit M0.

Now, an example of the fixed value and the correction value of the printing head 810 is described in detail. In light of the fact that reusing the printing head 810 is drawing attention from the viewpoint of protection of environment, specific description is given below on the fixed value and the correction value by taking a case of practicing such reuse as an example.

When a newly manufactured printing head 810 is shipped out, a dedicated test apparatus is used to measure an optimum ejection energy, that is, drive pulse width, and that information is stored in the memory circuit M0 as the fixed value. For example, the drive pulse width is managed with use of a plurality of rank values, and one of those rank values that is optimum based on a result of the measurement is stored in the memory circuit M0 as the fixed value. The memory circuit M0 is configured so as to be capable of storing as many bits of information (bit data) as required to store a rank value. In this embodiment, it is assumed that the drive pulse width is managed with the use of rank values that are from 1 to 255. In this case, the memory circuit M0 has a capacity of as many bits as required to store 255 different pieces of information, that is, a capacity of 8 bits.

The printing head 810 that has used up the ink charged at the time of manufacture becomes reusable by washing interior of the printing head 810 and charging ink again (first-time reuse). In this case, a drive condition optimum for the reused printing head 810 may differ from an optimum drive condition at the time of manufacture of the head. Accordingly, an optimum rank value is acquired in the first-time reuse as well by measuring an optimum ejection energy (the drive pulse width) with the use of the dedicated test apparatus. A change amount of the optimum rank value in the reuse with respect to the optimum rank value at the time of manufacture of the head, that is, an amount of change of the fixed value before and after an update, is then stored as the correction value (correction value 1) in the memory circuit M1.

The printing head 810 that has used up the ink charged in the first-time reuse becomes further reusable by washing the interior of the printing head 810 and charging ink again (second-time reuse). In this case, a drive condition optimum for the reused printing head 810 may differ from the optimum drive condition in the first-time reuse. Accordingly, an optimum rank value is acquired in the second-time reuse as well by measuring an optimum ejection energy (the drive pulse width) with the use of the dedicated test apparatus. A change amount of the optimum rank value in the second-time reuse with respect to the optimum rank value calculated in the first-time reuse, that is, an amount of change of the fixed value before and after an update, is then stored as the correction value (correction value 2) in the memory circuit M2.

Preferred timing of storing the correction value in the memory circuit M1 or M2 is a test step executed in a period after the recharging of ink to re-shipment, and a difference between a latest rank value acquired in the test step and the optimum rank value calculated the last time is stored as the bit data.

In this embodiment, the memory circuit M1 used in the first-time reuse and the memory circuit M2 used in the second-time reuse each have a capacity for storing 2 bits of information (bit data). A reason thereof is briefly described below.

It has been known that the optimum drive pulse width of the printing head 810 remains the same or slightly decreases in a period between the time of new manufacture and the first-time reuse, and a period between the first-time reuse and the second-time reuse. For example, repetition of the heater energization in ejection of ink droplets shaves a film on a surface of the heater little by little. When the film on the surface of the heater is shaved, heat of the heater is easily transmitted to the ink. Accordingly, with the shaving of the film on the surface of the heater, the drive pulse width optimum for ejection decreases in a corresponding manner. However, the change of the drive pulse width varies depending on the type of the ink that is used, the material of the film, and the like. In the printing head 810 of this embodiment, the rank value of the drive pulse width changes by three ranks at maximum per reuse. The memory circuits M1 and M2 are each set to a bit count of 2 so as to be capable of storing a correction value that indicates three ranks of change at maximum. It is assumed that, with a decrease in drive pulse width, the rank value increases.

Although the printing head 810 is reused twice in the description of this embodiment, the number of times of reuse is not limited to two and may be any number. Three or more times of reuse is achieved by providing as many memory circuits for storing correction values as the number of times of reuse. That is, three or more times of reuse is achieved by providing the same number of correction value memory circuits as the number of times of reuse. A capacity of the correction value memory circuit included for each time of reuse is set smaller than the capacity of the main memory circuit M0.

In FIG. 3, only the memory circuits M0 to M2 are illustrated as memory circuits, but memory circuits (OTP memories) that store various fixed values such as a serial number and other rank values may be provided.

Next, specific configurations of the memory circuits M0 to M2 are described. The memory circuits M1 and M2 have the same configuration as the configuration of the memory circuit M0, except for the number of elements in the circuit. Accordingly, the configuration of the memory circuit M0 is described in detail, and detailed description on the memory circuits M1 and M2 is omitted here.

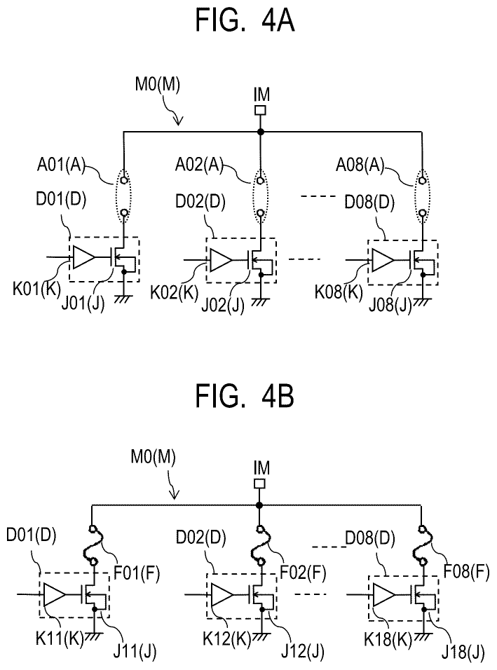

FIG. 4A is a schematic diagram for illustrating a configuration example of the memory circuit M0. This memory circuit M0 is configured by connecting eight antifuse elements A01 to A08 in parallel so as to be capable of storing 8 bits of data. Illustration of the antifuse elements A03 to A07 is omitted. The antifuse elements A01 to A08 are each in a non-conductive state, which is an initial state.

One end of the antifuse element A01 is connected to a terminal IM, and another end of the antifuse element A01 is grounded via a transistor J01. The transistor J01 is, for example, a field effect transistor (FET) of a metal oxide film semiconductor (MOS) type. One terminal (a source or a drain) of the transistor J01 is connected to the antifuse element A01, and another terminal of the transistor J01 is set to a ground potential (GND). A drive voltage conversion element K01 which generates a voltage for driving of the transistor J01 is connected to a gate terminal of the transistor J01. When a value of a voltage supplied to the gate terminal exceeds a threshold value, the transistor J01 shifts from a non-conductive state to a conductive state. When the transistor J01 shifts to the conductive state, a power supply voltage supplied to the terminal IM is applied to the antifuse element A01.

The antifuse elements A02 to A08 have the same structure as the structure of the antifuse element A01: the antifuse elements A02 to A08 are connected at one end to the terminal IM and are grounded at another end via transistors J02 to J08, respectively. Drive voltage conversion elements K02 to K08 which generate voltages for driving of the transistors J02 to J08, respectively, are connected to gate terminals of the transistors J02 to J08, respectively. The transistor J01 and the drive voltage conversion element K01 form a driver circuit D01. Similarly, the transistors J02 to J08 and the drive voltage conversion elements K02 to K08 form driver circuits D02 to D08, respectively. Illustration of the transistors J03 to J07, the drive voltage conversion elements K03 to K07, and the driver circuits D03 to D07 is omitted.

Each of the memory circuits M1 and M2 includes two elements as each of the antifuse elements A, the transistors J, and the drive voltage conversion elements K which form the memory circuit M0, and is thus configured so as to be capable of storing 2 bits of data.

In the memory circuits M0 to M2 described above, data is writable by selectively establishing electrical conduction of the antifuse elements A. A dedicated apparatus or the printing apparatus 900 is usable for establishment of electrical conduction of the antifuse elements A. To establish electrical conduction of one of the antifuse elements A, one of the transistors J that is connected to the one of the antifuse elements A is turned on, and a high voltage is applied between two electrodes that form the one of the antifuse elements A. This causes insulation breakdown of a gate oxide film between the two electrodes, with the result that a conductive state is created. In order to turn on a desired one of the transistors J, the shift register 110 for memory is controlled so as to set a signal level of one of the drive voltage conversion elements K that is connected to the object one of the transistors J to High.

As an example, a procedure of establishing electrical conduction of the antifuse element A01 of the memory circuit M0 illustrated in FIG. 4A is described. In the printing apparatus 900, the constant voltage circuit 203 supplies a direct-current voltage of 24 volts via the contact pad 815 to the terminal IM of the memory circuit M0. The memory control circuit 204 then outputs a data signal DATAM and a latch signal LTM to the shift register 110 for memory. The memory control circuit 204 performs control so that only the drive voltage conversion element K01 in the memory circuit M0 is at a High level, with the drive voltage conversion elements K02 to K08 set to a Low level. This causes the transistor J01 alone to be turned on, and the voltage of 24 volts supplied to the terminal IM to be applied to the antifuse element A01. When turning on and off of this voltage application is repeated at a high speed, electrical conduction of the antifuse element A01 is established. In this embodiment, electrical conduction of the antifuse element A01 is established by repeating turning on and off of the voltage application at a frequency of 6 MHz. The number of times voltage application is turned on and off that is required to establish electrical conduction of an antifuse element is said to be 10,000 times on average, but, due to an individual difference of an antifuse element, 60,000 times of turning on and off is required to establish electrical conduction in some cases. Accordingly, in this embodiment, the number of times the voltage application is turned on and off is set to the maximum count of 60,000.

In the description given above on the operation, the constant voltage circuit 203 supplies a direct-current voltage of 24 volts to the terminal IM of the memory circuit M0, but this embodiment is not limited thereto. The driver driving power generating circuit 153 outputs a direct-current voltage of 24 volts as well, and may be used in place of the constant voltage circuit 203. In this case, the constant voltage circuit 203 can be omitted.

Next, a method of reading whether the antifuse elements A are in a conductive state or a non-conductive state in the above-mentioned memory circuits M0 to M2 is described. A dedicated apparatus or the printing apparatus 900 is usable to execute this reading of the states of the antifuse elements A.

As an example, reading of the states of the antifuse elements A01 to A08 of the memory circuit M0 illustrated in FIG. 4A is described. The number of antifuse elements that can be read in one reading operation is one, and the states of the antifuse elements A01 to A08 are accordingly read one antifuse element at a time, eight times in total.

In order to read the state of the antifuse element A01, the transistor J01 is required to be turned on. In the printing apparatus 900, the memory control circuit 204 outputs a signal to the shift register 110 for memory. The memory control circuit 204 performs control so that the drive voltage conversion element K01 alone is at the High level, with the drive voltage conversion elements K02 to K08 set to the Low level. Next, the constant current circuit 201 supplies a constant current to the terminal IM, and the voltage detecting circuit 202 measures a voltage of the terminal IM to determine whether the measured voltage is the same as a voltage of a terminal GND. When the voltage of the terminal IM is the same as the voltage of the terminal GND, it can be determined that the antifuse element A01 is in a conductive state. When the antifuse element A01 is in a non-conductive state, on the other hand, the constant current circuit 201 operates so as to cause a current flow all the time, and may consequently break down. In this embodiment, a limiter function for avoiding the breakdown of the constant current circuit 201 is provided. This limiter function sets a limit voltage so that an internal voltage of the constant current circuit 201 is kept from rising to a certain level or higher. When the internal voltage reaches the limit voltage, output of the constant current circuit 201 is stopped. When the limiter function comes into effect, it can be determined that the antifuse element A01 is in a non-conductive state.

The states of the antifuse elements A02 to A08 are readable by the same procedure as the procedure of reading the state of the antifuse element A01 described above.

FIG. 4B is a schematic diagram for illustrating another configuration example of the memory circuit M0. This memory circuit M0 is configured by connecting eight fuse elements F01 to F08 in parallel so as to be capable of storing 8 bits of data. Illustration of the fuse elements F03 to F07 is omitted. The fuse elements F01 to F08 are each in a conductive state, which is an initial state.

One end of the fuse element F01 is connected to a terminal IM, and another end of the fuse element F01 is grounded via a transistor J11. The fuse elements F02 to F08 have the same structure as the structure of the fuse element F01: the fuse elements F02 to F08 are connected at one end to the terminal IM and are grounded at another end via transistors J12 to J18, respectively. The transistors J11 to J18 are the same as the transistors J01 to J08 illustrated in FIG. 4A. Drive voltage conversion elements K11 to K18 which generate voltages for driving of the transistors J11 to J18, respectively, are connected to gate terminals of the transistors J11 to J18, respectively. The drive voltage conversion elements K11 to K18 are the same as the drive voltage conversion elements K01 to K08 illustrated in FIG. 4A, respectively. The transistor J11 and the drive voltage conversion element K11 form a driver circuit D01. Similarly, the transistors J12 to J18 and the drive voltage conversion elements K12 to K18 form driver circuits D02 to D08, respectively. Illustration of the transistors J13 to J17, the drive voltage conversion elements K13 to K17, and the driver circuits D03 to D07 is omitted.

Each of the memory circuits M1 and M2 includes two elements as each of the fuse elements F, the transistors J, and the drive voltage conversion elements K which form the memory circuit M0, and is thus configured so as to be capable of storing 2 bits of data.

In the memory circuits M0 to M2 described above, data is writable by selectively disconnecting the fuse elements F. A dedicated apparatus or the printing apparatus 900 is usable to disconnect the fuse elements F. To disconnect one of the fuse elements F, one of the transistors J that is connected to the one of the fuse elements F is turned on, and a large current is caused to flow in the one of the fuse elements F. When a large current flows in the one of the fuse elements F, the one of the fuse elements F generates heat and then melts down.

As an example, a procedure of disconnecting the fuse element F02 of the memory circuit M0 illustrated in FIG. 4B is described. In the printing apparatus 900, the constant voltage circuit 203 supplies a direct-current voltage of 24 volts via the contact pad 815 to the terminal IM of the memory circuit M0. The memory control circuit 204 then outputs a data signal DATAM and a latch signal LTM to the shift register 110 for memory. The memory control circuit 204 performs control so that only the drive voltage conversion element K12 in the memory circuit M0 is at a High level, with the drive voltage conversion elements K11 and K13 to K18 set to a Low level. This causes the transistor J12 alone to be turned on, and the voltage of 24 volts supplied to the terminal IM to be applied across the terminals of the fuse element F02. A resistance value of the fuse element F02 is very small, and a large current accordingly flows in the fuse element F02. As a result, the fuse element F02 generates heat and melts down. In this embodiment, the fuse elements F01 to F08 are all configured so as to melt down when a current of 70 milliamperes or more flows therein. In this case also, the driver driving power generating circuit 153 may be used in place of the constant voltage circuit 203.

A procedure of reading whether the fuse elements F are in a conductive state or a non-conductive state in the memory circuits M0 to M2 described above is basically the same as in the above-mentioned reading of the states of the antifuse elements A. Description on reading of the states of the fuse element F is omitted in order to avoid duplicate description.

This concludes the description on the specific configurations of the memory circuits M0 to M2, the data writing method, and the data reading method.

Next, specific description is given on data stored in the memory circuit M0. In the following description, the memory circuit M0 illustrated in FIG. 4A is taken as an example, and a rank value of the drive pulse width measured at the time the printing head 810 has newly been manufactured is “200.”

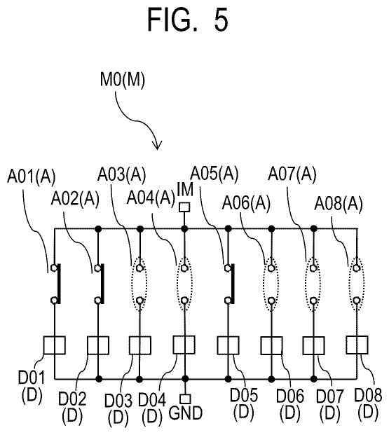

A state in which the rank value “200” is written in the memory circuit M0 is schematically illustrated in FIG. 5. The memory circuit M0 stores binary data by controlling the conductive or non-conductive state of the antifuse elements A01 to A08. Specifically, the antifuse elements A01 and A08 are allocated the most significant bit and the least significant bit, respectively, and the conductive state and the non-conductive state are represented by “1” and “0,” respectively. The memory circuit M0 stores the rank value “200” which is a decimal number as “11001000” which is a binary number of 8 bits. In this case, the antifuse elements A01, A02, and A05 are in a conductive state, and the antifuse elements A03, A04, and A06 to A08 are in a non-conductive state.

Next, data recognition processing in which the printing apparatus 900 reads the states of the memory circuits M0 to M2 and recognizes the rank value of the drive pulse width is described. Here, it is assumed that the printing head 810 has newly been manufactured, and that “200” is stored in the memory circuit M0 as an initial value of a rank of the drive pulse width as illustrated in FIG. 5. The memory circuits M1 and M2 are both in an initial state (all antifuse elements A are in a non-conductive state), that is, data of every bit is “0,” because the printing head 810 is yet to be reused.

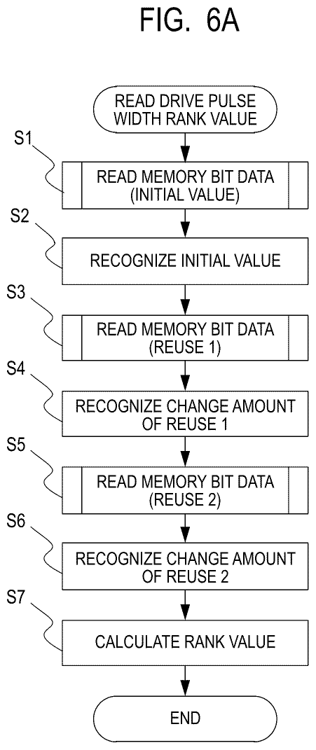

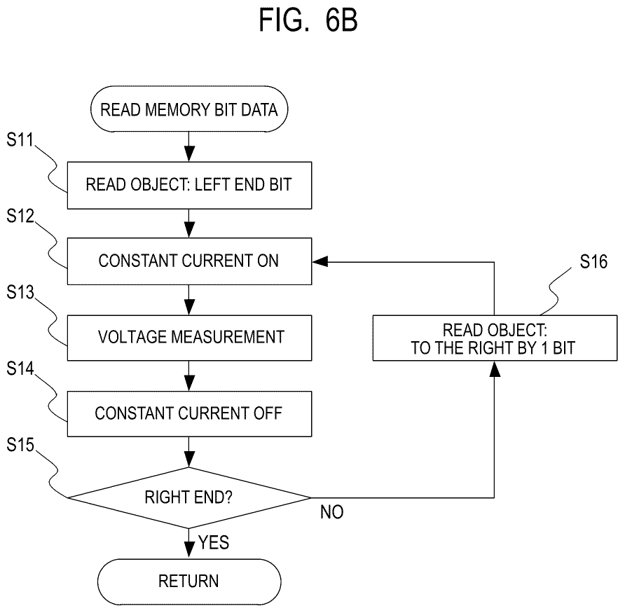

FIG. 6A and FIG. 6B are flow charts of the data recognition processing in which the control unit 10 of the printing apparatus 900 recognizes rank values of the drive pulse width that are stored in the memory circuits M (M0 to M2). FIG. 6A is a flow chart for overall recognition processing (hereinafter referred to as “main flow”), and FIG. 6B is a detailed flow chart for reading respective pieces of bit data of the memory circuits M (M0 to M2).

First, in Step S1, the control unit 10 reads data stored in the memory circuits M. Here, whether the bit data is “0” or “1” is read for each piece of 8-bit data in total stored in the memory circuit M0. The method of reading data of 1 bit is already described, and reading of entire bits of a memory is accordingly described here.

In Step S11, a bit that is a read object is determined. The number of bits that can be read in one reading operation is one, and the bits are read one bit at a time, starting from a left end bit of the memory circuit M0. The state of the antifuse element A01 which is the left end bit is read first in Step S11. The memory control circuit 204 outputs a signal to the shift register 110 for memory to set the drive voltage conversion element K01 alone to the High level, and set the drive voltage conversion elements K02 to K08 as well as all drive voltage conversion elements K of the memory circuits M1 and M2 to the Low level. Only the transistor J01 connected to the antifuse element A01 is thus turned on.

Next, in Step S12, the constant current circuit 201 supplies a constant current to the terminal IM. In this embodiment, a current of 20 microamperes is caused to flow. In that state, in Step S13, the voltage detecting circuit 202 determines whether the voltage of the terminal IM is the same as the voltage of the terminal GND by voltage measurement. In a case in which the terminal IM is substantially equal in voltage to the terminal GND, the bit is “1” (the antifuse element A01 is in a conductive state), and the bit is otherwise “0.” After the voltage measurement, output of the constant current from the constant current circuit 201 is stopped in Step S14. With regard to the data read here, data of which bit has which of the values “0” and “1” is stored on a storage unit (not shown) in the printing apparatus 900.

Next, in Step S15, whether the read bit is a right end bit is determined. In a case of the right end bit, the process returns to the main flow. In a case in which the read bit is not the right end bit, a bit to be read next is set in Step S16. At this point in the description, the read bit is not the right end bit, the process accordingly proceeds to Step S16 in which the memory control circuit 204 controls the shift register 110 for memory so that the bit to be read next is a bit to the immediate right (in this case, second from the left). The process then returns to Step S12 in which the second bit from the left is read. This processing is repeated until reading of the right end bit is completed and, upon completion of the reading of the right end bit, the process returns to the main flow.

Returning to the main flow, in Step S2, an actual rank value stored in the memory circuit M0 read in Step S1 is recognized. In Step S1, stored data which is a result of reading one bit at a time from the left end bit to the right end bit in order is recognized as an 8-bit value. The read data is 1·1·0·0·1·0·0·0 from the left end bit in order, and those pieces of data are accordingly treated as binary 8-bit data “11001000” to be recognized as a rank value “200” in decimal form.

Next, in Step S3, data stored in the memory circuit M1 is read. Processing of reading the data is as in the data read flow of Step S1 described with reference to FIG. 6B as a flow for reading data of each bit of the memory. Two bits of data are read out of the memory circuit M1. At this point in the description, the printing head 810 is yet to be reused, and the memory circuit M1 is accordingly in an initial state (all bits are “0”). It is thus recognized in the next step which is Step S4 that the rank value has changed in the first-time reuse by “0.”

Next, in Step S5, data stored in the memory circuit M2 is read. Processing of reading the data is as in the data read flow of Step S1 described with reference to FIG. 6B as a flow for reading data of each bit of the memory. Two bits of data are read out of the memory circuit M2. At this point in the description, the printing head 810 is yet to be reused, and the memory circuit M2 is accordingly in an initial state (all bits are “0”). It is thus recognized in the next step which is Step S6 that the rank value has changed in the second-time reuse by “0.”

Lastly, in Step S7, a rank value is calculated based on the respective pieces of data (the fixed value and the correction values) recognized in Step S2, Step S4, and Step S6. At this point in the description, the printing head 810 is yet to be reused, and the initial value “200” recognized in Step S2 is accordingly recognized as the rank value of the drive pulse width.

Operation in a case in which the printing head 810 has been reused (for the first time) is described next. In the description given here, the rank value of the drive pulse width at the time of manufacture (the initial value) is “200,” and it is assumed that the rank has changed to “202” by reusing the printing head 810 once.

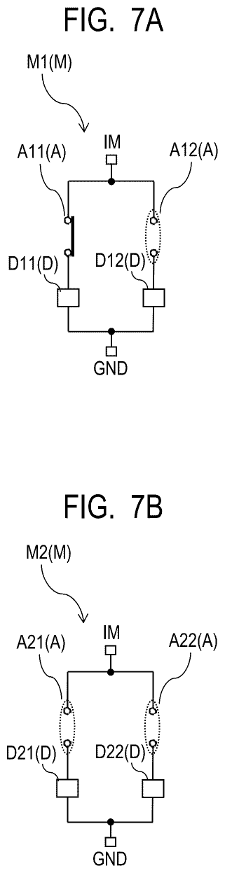

States of the memory circuits M1 and M2 in the first-time reuse are schematically illustrated in FIG. 7A and FIG. 7B. FIG. 7A is the state of the memory circuit M1 and FIG. 7B is the state of the memory circuit M2. The memory circuit M1 is a 2-bit memory in which two antifuse elements A11 and A12 are connected in parallel. The antifuse elements A11 and A12 are connected to a GND terminal via driver circuits D11 and D12, respectively. The antifuse elements A11 and A12 and the driver circuits D11 and D12 have the same structures as the structures of the antifuse elements A and the driver circuits D, respectively, of the memory circuit M0 illustrated in FIG. 4A. The memory circuit M2 is also a 2-bit memory in which two antifuse elements A21 and A22 are connected in parallel. The antifuse elements A21 and A22 are connected to a GND terminal via driver circuits D21 and D22, respectively. The antifuse elements A21 and A22 and the driver circuits D21 and D22 have the same structures as the structures of the antifuse elements A and the driver circuits D, respectively, of the memory circuit M0 illustrated in FIG. 4A.

In the first-time reuse, the drive pulse width is measured, and a difference (how much the rank value has changed) of the rank value thereof from the initial value (“200”) is stored in the memory circuit M1 as a correction value. Here, an optimum drive pulse width rank in the first-time reuse is “202” and has increased by “2” from the initial value “200.” The decimal number “2” is expressed as “10” in binary form. Of the two bits of the memory circuit M1, the more significant bit is the antifuse element A11 and the less significant bit is the antifuse element A12. Accordingly, the antifuse element A11 is in a conductive state and the antifuse element A12 is in a non-conductive state. The memory circuit M2 is in an initial state (antifuse elements A21 and A22 are in a non-conductive state), that is, “0” because the printing head 810 is yet to be reused for the second time.

Processing executed by the control unit 10 of the printing apparatus 900 to recognize an optimum rank value of the drive pulse width when the memory circuits M1 and M2 are in the states illustrated in FIG. 7A and FIG. 7B is described below. This recognition processing is executed by the procedure illustrated in FIG. 6A and FIG. 6B, but part of the processing differs from the preceding description.

The processing steps of Step S1 and Step S2 are as described above. Next, in Step S3, data stored in the memory circuit M1 is read. Processing of reading the data is as in the data read flow of Step S1 described with reference to FIG. 6B as a flow for reading data of each bit of the memory. Two bits of data are read out of the memory circuit M1. Here, that the more significant bit and the less significant bit out of the two bits are “1” and “0,” respectively, is read.

In Step S4, it is recognized that “10” in binary form, that is, “2” in decimal form is stored in the memory circuit M1 because the more significant bit is “1” and the less significant bit is “0.” The processing steps of Step S5 and Step S6 are as described above. In rank value calculation of Step S7, because the memory circuit M2 is “0,” “202” obtained by adding “2” of the memory circuit M1 (how much the rank value has changed in the first-time reuse) to “200” (the initial value) of the memory circuit M0 is recognized to be the latest rank value of the drive pulse width.

This concludes the description on the processing of recognizing the rank value of the drive pulse width of the printing head 810 that has been reused once.

Operation in a case in which the printing head 810 is reused further (for the second time) is described next. Here, the rank value of the drive pulse width at the time of manufacture (the initial value) is “200,” and the rank value of the drive pulse width in the first-time reuse is “202.” A rank value corresponding to the drive pulse width measured in the second-time reuse is “203.”

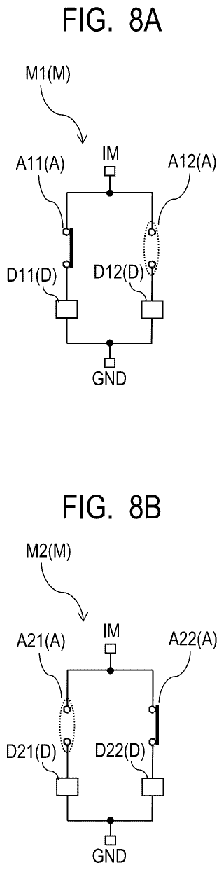

States of the memory circuits M1 and M2 in the second-time reuse are schematically illustrated in FIG. 8A and FIG. 8B. FIG. 8A is the state of the memory circuit M1 and FIG. 8B is the state of the memory circuit M2. In the second-time reuse, the drive pulse width is measured, and a difference (how much the rank value has changed) of the rank value thereof from the rank value “202” in the first-time reuse is stored in the memory circuit M2 as a correction value. Here, an optimum drive pulse width rank in the second-time reuse is “203” and has increased by “1” from the rank value “202” in the first-time reuse. The decimal number “1” is expressed as “01” in binary form. Of the two bits of the memory circuit M2, the more significant bit is the antifuse element A21 and the less significant bit is the antifuse element A22. Accordingly, the antifuse element A21 is in a non-conductive state and the antifuse element A22 is in a conductive state.

Processing executed by the control unit 10 of the printing apparatus 900 to recognize an optimum rank value of the drive pulse width when the memory circuits M1 and M2 are in the states illustrated in FIG. 8A and FIG. 8B is described below. This recognition processing is executed by the procedure illustrated in FIG. 6A and FIG. 6B, but part of the processing differs from the preceding description.

The processing steps of from Step S1 to Step S4 are as described above. Next, in Step S5, data stored in the memory circuit M2 is read. Processing of reading the data is as in the data read flow of Step S1 described with reference to FIG. 6B as a flow for reading data of each bit of the memory. Two bits of data are read out of the memory circuit M2. Here, that the more significant bit and the less significant bit out of the two bits are “0” and “1,” respectively, is read.

In Step S6, it is recognized that “01” in binary form, that is, “1” in decimal form is stored in the memory circuit M2 because the more significant bit is “0” and the less significant bit is “1.” In Step S7, “203” obtained by adding “2” of the memory circuit M1 (how much the rank value has changed in the first-time reuse) and “1” of the memory circuit M2 (how much the rank value has changed in the second-time reuse) to “200” (initial value) of the memory circuit M0 is recognized to be the latest rank value of the drive pulse width.

This concludes the description on the processing of recognizing the rank value of the drive pulse width of the printing head 810 that has been reused twice. Step S1 and Step S2 can be called “fixed value recognition step.” Step S3 to Step S6 can be called “correction value recognition step.” Step S7 can be called “calculation step.”

As described above, according to the printing head 810 of this embodiment, provision of the memory circuits M1 and M2 for correcting the fixed value (initial value) enables updating of the fixed value. Specifically, the latest fixed value of the printing head 810 can be recognized all the time by storing, in a case in which the fixed value stored when the printing head 810 is newly manufactured changes in reuse, how much the fixed value has changed in the memory circuits M1 and M2.

In addition, the memory circuits M1 and M2 are each sufficiently smaller in memory capacity than the memory circuit M0, and an increase in memory capacity can thus be suppressed compared to a case in which a memory circuit having a memory capacity equivalent to that of the memory circuit M0 is separately provided.

Further, an increase in size of the printing head 810 can be suppressed because the memory circuits M0 to M2 have simple circuit configurations and require small areas to be formed.

In the printing head 810 according to this embodiment, any of fuse elements and antifuse elements may be used to configure the memory circuits M0 to M2. However, a memory circuit that uses antifuse elements is smaller in area required to be formed than a memory circuit that uses fuse elements. For example, an area of a memory circuit that uses antifuse elements can be reduced to approximately one third of an area of a memory circuit that uses fuse elements. Accordingly, antifuse elements are preferred to be used to form the memory circuits M0 to M2.

The fixed value stored in the memory circuit M0 is not limited to the rank value of the drive pulse width. The fixed value may be a rank value of any type of data as long as the data is updatable based on the correction value.

### Second Embodiment

A printing head according to a second embodiment of the present disclosure is described. The printing head according to this embodiment has the same configuration as the configuration of the printing head 810 according to the first embodiment, except that the fixed value increases and decreases. In description of the printing head according to this embodiment, a component that is the same as in the first embodiment is denoted by the same reference symbol as in the first embodiment. Description on matters that are the same as in the first embodiment is omitted here.

In the printing head 810 according to the first embodiment, the fixed value (the rank value of the drive pulse width) in reuse changes in a plus direction. In contrast, in the printing head 810 according to this embodiment, the fixed value changes in the plus direction or a minus direction. An example of storing the fixed value that is called a density rank at which a density of a liquid droplet ejected from the printing head 810 and landing on a sheet surface is ranked is described below. However, the fixed value is not limited to the density rank. Any type of data is usable as the fixed value as long as the data is of a type that changes in the plus direction or the minus direction due to reuse.

A density rank value is a value at which a density value of a landing pattern (a pattern of a printed material) on a sheet surface that is measured with a density meter when the printing head 810 is driven at the drive pulse width described in the first embodiment is ranked. The printing apparatus 900 reads this density rank value and, when a solid pattern or a halftone pattern is printed, controls the number of ink droplets to be ejected by the density rank value so that the printed pattern has a desired density level. This density rank value sometimes changes slightly in the plus direction or the minus direction in reuse, and a change amount thereof is known to be within 2.

Electrical connection between the element substrate 100 of the printing head 810 according to this embodiment and the main-body portion 900a of the printing apparatus 900 is as illustrated in FIG. 3. However, the memory circuit M0 stores the density rank value, the memory circuit M1 stores how much the density rank value has changed in the first-time reuse, and the memory circuit M2 stores how much the density rank value has changed in the second-time reuse. In this embodiment, the density rank is managed with rank values ranging from “0” to “31.” In this case, the memory circuit M0 has a capacity of 5 bits. Data is read out of and written to the memory circuits M0 to M2 by the same methods as the data read method and the data write method in the first embodiment.

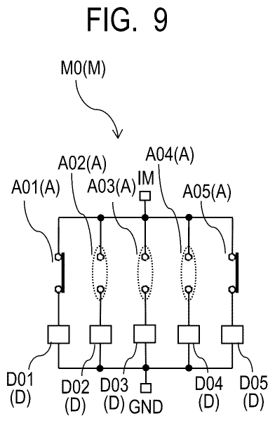

FIG. 9 is a schematic diagram for illustrating a configuration of the memory circuit M0 that stores the density rank value. This memory circuit M0 includes five antifuse elements A01 to A05 connected in parallel, and is configured so as to be capable of storing 5 bits of data. Driver circuits D01 to D05 are connected to the antifuse elements A01 to A05, respectively. The antifuse elements A01 to A05 and the driver circuits D01 to D05 have the same structures as the structures of the antifuse elements A and the driver circuits D, respectively, of the memory circuit M0 described in the first embodiment.

In the example of FIG. 9, an initial value of the density rank is “17.” The decimal number “17” is expressed as “10001” in binary form. In the memory circuit M0, the antifuse elements A01 and A05 are in a conductive state and the antifuse elements A02, A03, and A04 are in a non-conductive state in order to store “10001.”

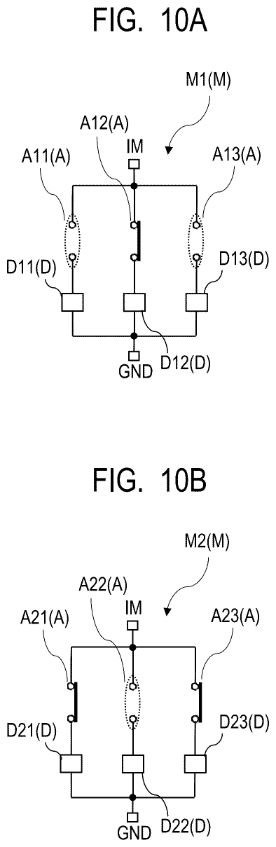

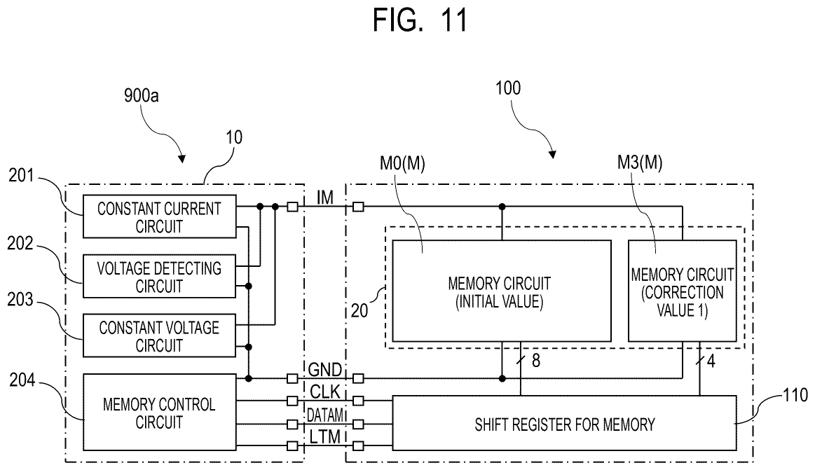

FIG. 10A and FIG. 10B are schematic diagrams for illustrating configurations of the memory circuits M1 and M2 that store change amounts of the density rank value. FIG. 10A is an illustration of the memory circuit M1 and FIG. 10B is an illustration of the memory circuit M2.

The memory circuit M1 illustrated in FIG. 10A is a memory of 3 bits in which three antifuse elements A11 to A13 are connected in parallel. Driver circuits D11 to D13 are connected to the antifuse elements A11 to A13, respectively. The antifuse element A11 at a left end indicates a positive or negative sign, and the remaining antifuse elements A12 and A13 are used to store 2 bits of data. The positive or negative sign here indicates whether the correction value is to be added to the fixed value or subtracted from the fixed value. The antifuse elements A11 to A13 and the driver circuits D11 to D13 have the same structures as the structures of the antifuse elements A and the driver circuits D, respectively, of the memory circuit M1 described in the first embodiment.

In the example of FIG. 10A, the rank value has changed by plus 2 in the first-time reuse. To indicate “plus,” the antifuse element A11 is in a non-conductive state in the memory circuit M1. The decimal number “2” is expressed as “10” in binary form. In order to store “10,” the memory circuit M1 sets the antifuse element A12 to a conductive state and sets the antifuse element A13 to a non-conductive state.

The memory circuit M2 illustrated in FIG. 10B is a memory of 3 bits in which three antifuse elements A21 to A23 are connected in parallel. Driver circuits D21 to D23 are connected to the antifuse elements A21 to A23, respectively. The antifuse element A21 at a left end indicates a positive or negative sign, and the remaining antifuse elements A22 and A23 are used to store 2 bits of data. The antifuse elements A21 to A23 and the driver circuits D21 to D23 have the same structures as the structures of the antifuse elements A and the driver circuits D, respectively, of the memory circuit M2 described in the first embodiment.

In the example of FIG. 10B, the rank value has changed by minus 1 in the second-time reuse. To indicate “minus,” the antifuse element A21 is in a conductive state in the memory circuit M2. The decimal number “1” is expressed as “01” in binary form. In order to store “01,” the memory circuit M2 sets the antifuse element A22 to a non-conductive state and sets the antifuse element A23 to a conductive state.

Data recognition processing in which the control unit 10 of the printing apparatus 900 recognizes the density rank value by reading the states of the memory circuits M0 to M2 is described next. A flow for reading data stored in the memory circuits M0 to M2 is the same as the flow for reading the rank value of the drive pulse width which is illustrated in FIG. 6A and FIG. 6B, except that the positive or negative sign is attached to a change amount (correction value) in reuse. Here, recognition processing in which the change amount in reuse is recognized is described.

The printing head 810 has been reused twice, and the memory circuits M1 and M2 are in the states illustrated in FIG. 10A and FIG. 10B, respectively. The pieces of bit data of the memory circuit M1 in the first-time reuse are “0” in the antifuse element A11, “1” in the antifuse element A12, and “0” in the antifuse element A13. The antifuse element A11 is a sign bit indicating positive or negative. The antifuse elements A12 and A13 are the more significant bit and the less significant bit, respectively, of 2-bit data. It is recognized that the change is in the plus direction because the sign bit is “0.” The 2-bit data is “10” in binary form, that is, “2” in decimal form, and it is accordingly recognized that the change in the first-time reuse is by plus 2.

The pieces of bit data of the memory circuit M2 in the second-time reuse are “1” in the antifuse element A21, “0” in the antifuse element A22, and “1” in the antifuse element A23. The antifuse element A21 is a sign bit indicating positive or negative. The antifuse elements A22 and A23 are the more significant bit and the less significant bit, respectively, of 2-bit data. It is recognized that the change is in the minus direction because the sign bit is “1.” The 2-bit data is “01” in binary form, that is, “1” in decimal form, and it is accordingly recognized that the change in the second-time reuse is by minus 1.

The control unit 10 of the printing apparatus 900 recognizes, with respect to the printing head 810 that has been reused twice, as the latest density rank, “18” obtained by totaling the initial rank value “17,” “plus 2” by which the rank value has changed in the first-time reuse, and “minus 1” by which the rank value has changed in the second-time reuse.

As described above, according to the printing head 810 of this embodiment, the fixed value is updatable even when the fixed value is of a type that changes in reuse in an increasing or decreasing manner, and the latest fixed value of the printing head 810 can accordingly be recognized.

In the printing head 810 according to this embodiment, any of fuse elements and antifuse elements may be used to configure the memory circuits M0, M1, and M2 as in the first embodiment. However, as described in the first embodiment, a memory circuit that uses antifuse elements is smaller in area than a memory circuit that uses fuse elements, and antifuse elements are accordingly preferred to be used.

### Third Embodiment

A printing head according to a third embodiment of the present disclosure is described. In the printing head 810 according to the first embodiment and the printing head 810 according to the second embodiment, as many number of memory circuits as the number of times of reuse are provided to store how much the fixed value has changed in reuse. The printing head according to this embodiment differs from those of the first and second embodiments in that a memory circuit storing a change amount of the fixed value in reuse is used in common for every reuse. In description of the printing head according to this embodiment, a component that is the same as in the first and second embodiments is denoted by the same reference symbol as in the first embodiment and second embodiments. Description on matters that are the same as in the first embodiment and second embodiments is omitted here.

FIG. 11 is a schematic diagram for illustrating a configuration of the printing head 810 according to the third embodiment of the present disclosure. In FIG. 11, electrical connection between the main-body portion 900a of the printing apparatus 900 and the element substrate 100 of the printing head 810 is schematically illustrated. In FIG. 11, only portions related to the memory circuits are illustrated, and other elements are omitted.

The main-body portion 900a of the printing apparatus 900 includes the control unit 10. The control unit 10 includes the constant current circuit 201, the voltage detecting circuit 202, and the constant voltage circuit 203. Those circuits are basically the same as the ones described in the first embodiment. The memory control circuit 204, the heater control circuit 151, the heater power generating circuit 152, the driver driving power generating circuit 153, and the logic power circuit 154 are omitted.

The element substrate 100 includes the memory unit 20 and the shift register 110 for memory. The memory unit 20 includes the memory circuit (an initial value) M0 and a memory circuit (a correction value) M3. The memory circuit M3 can be called “correction value memory circuit.” The memory circuit M3 stores how much the rank value of the drive pulse width that is the fixed value has changed in reuse, that is, a correction value of the initial rank value. The memory circuit M3 is configured so as to be used in common for all of reuse. The memory circuit M0 and the shift register 110 for memory are basically the same as the ones described in the first embodiment. The heater circuit 101 and the shift register 102 for heater are omitted.

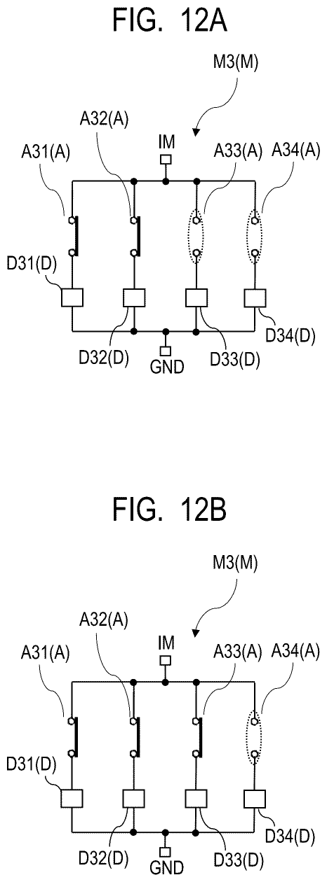

FIG. 12A and FIG. 12B are schematic diagrams for illustrating a configuration of the memory circuit M3. This memory circuit M3 includes four antifuse elements A31 to A34 connected in parallel, and is configured so as to be capable of storing 4 bits of data. Driver circuits D31 to D34 are connected to the antifuse elements A31 to A34, respectively. The antifuse elements A31 to A34 and the driver circuits D31 to D34 have the same structures as the structures of the antifuse elements A and the driver circuits D, respectively, of the memory circuit M0 described in the first embodiment.

In the example of FIG. 12A and FIG. 12B, the rank changes by three ranks at maximum per reuse. In this case, 2 bits at maximum are required per reuse, and, on the assumption that the printing head is reused twice, the memory circuit M3 is configured so as to be capable of storing 4 bits of data. The number of times of reuse is not limited to two. The number of times of reuse may be three or more. In this case, the number of antifuse elements A is increased based on the number of times of reuse.

In the memory circuit M3, data is written by establishing electrical conduction of the antifuse elements A. Here, data is written by establishing electrical conduction in order from one of the antifuse elements A that is at a left end of the memory circuit M3. When writing data, which ones of the antifuse elements A are to establish electrical conduction is determined after checking which ones of the antifuse elements A in the memory circuit M3 are in a conductive state. In a case in which the printing head has never been reused, all of the antifuse elements A in the memory circuit M3 are in a non-conductive state.

FIG. 12A is an illustration of a state of the memory circuit M3 in the first-time reuse, and the state of the memory circuit M3 in the second-time reuse is illustrated in FIG. 12B. Here, the rank has changed (increased) by “2” in the first-time reuse, and has changed by “1” in the second-time reuse.

In the first-time reuse, whether electrical conduction has been established is checked in order from the antifuse element A31 at the left end of the memory circuit M3, and which ones of the antifuse elements that are not in a conductive state are to establish electrical conduction this time is recognized. Here, all of the antifuse elements A31 to A34 of the memory circuit M3 are in a non-conductive state. The antifuse elements A31 and A32 are determined to be elements that are to establish electrical conduction because the rank value has increased by “2.” Electrical conduction is established for the two antifuse elements A31 and A32 as illustrated in FIG. 12A.

Also in the second-time reuse, whether electrical conduction has been established is checked in order from the antifuse element A31 at the left end of the memory circuit M3, and which ones of the antifuse elements that are not in a conductive state are to establish electrical conduction this time is recognized. Here, the antifuse elements A31 and A32 of the memory circuit M3 are in a conductive state. The antifuse element A33 is determined to be an element that is to establish electrical conduction because the rank value has increased by “1.” Electrical conduction is established for the antifuse element A33 as illustrated in FIG. 12B.

Processing in which the printing apparatus 900 reads the states of the memory circuits M0 and M3 to recognize the rank value of the drive pulse width is described next. The description given here assumes that the memory circuit M3 is in the state of FIG. 12B, with the memory circuit M0 storing a rank value “200.”

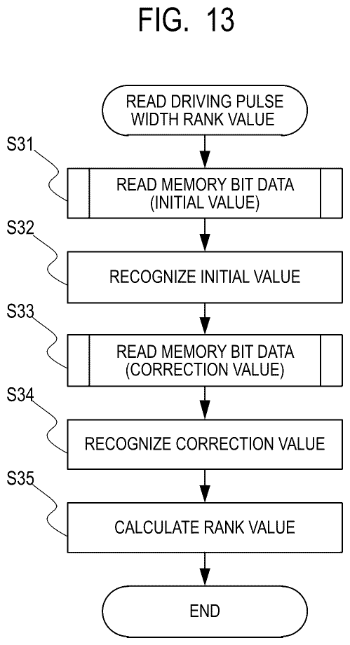

FIG. 13 is a flow chart of data recognition processing in which the control unit 10 of the printing apparatus 900 recognizes rank values of the drive pulse width that are stored in the memory circuits M (M0 and M3). A flow for memory bit data reading of Step S31 and Step S33 in the flow chart of FIG. 13 is the same as the flow illustrated in FIG. 6B, and illustration and description thereof are accordingly omitted. Processing of recognizing the initial value of the rank in Step S32 is the same as in the first embodiment, and description thereof is accordingly omitted here.

Step S31 and Step S32 are the same as Step S1 and Step S2 illustrated in FIG. 6A. In Step S33, data stored in the memory circuit M3 is read. Processing of reading the data is as in the data read flow of FIG. 6B in which data of each bit of the memory is read. Four bits of data are read out of the memory circuit M3. At this point in the description, the printing head has been reused twice, and pieces of bit data are accordingly read out of the memory circuit M3 in the state illustrated in FIG. 12B.

Next, in Step S34, a correction value indicated by the pieces of bit data of the memory circuit M3 that has been read in Step S33 is recognized. It has been read in Step S33 that electrical conduction has been established for the antifuse elements A31 to A33 of the memory circuit M3. Accordingly, it is recognized in Step S34 that the correction value is “3.”

Lastly, in Step S35, “203” obtained by totaling the initial rank value “200” and the correction value “3” is recognized to be the latest rank value of the drive pulse width. Step S31 and Step S32 can be called “fixed value recognition step”. Step S33 and Step S34 can be called “correction value recognition step.” Step S35 can be called “calculation step.”

As described above, according to the printing head 810 of this embodiment, update of the fixed value with use of the memory circuit M3 common to each reuse is achievable, and the latest fixed value of the printing head 810 can thus be recognized. The use of the common memory circuit M3 suppresses an increase in area required to form a memory.

In the printing head 810 according to this embodiment, any of fuse elements and antifuse elements may be used to configure the memory circuits M0 and M3. However, as described in the first embodiment, a memory circuit that uses antifuse elements is smaller in area than a memory circuit that uses fuse elements, and antifuse elements are accordingly preferred to be used.

### Fourth Embodiment

A printing head according to a fourth embodiment of the present disclosure is described. A component that is the same as in the first to the third embodiments is denoted by the same reference symbol as in the first to third embodiments. Description on matters that are the same as in the first to third embodiments is omitted here.

In the printing head 810 according to the third embodiment, the fixed value (the rank value of the drive pulse width) in reuse changes in a plus direction. In contrast, in the printing head 810 according to this embodiment, the fixed value changes in the plus direction or the minus direction. The fixed value in this embodiment is the density rank described in the second embodiment. A density rank value is the fixed value that increases or decreases due to reuse.

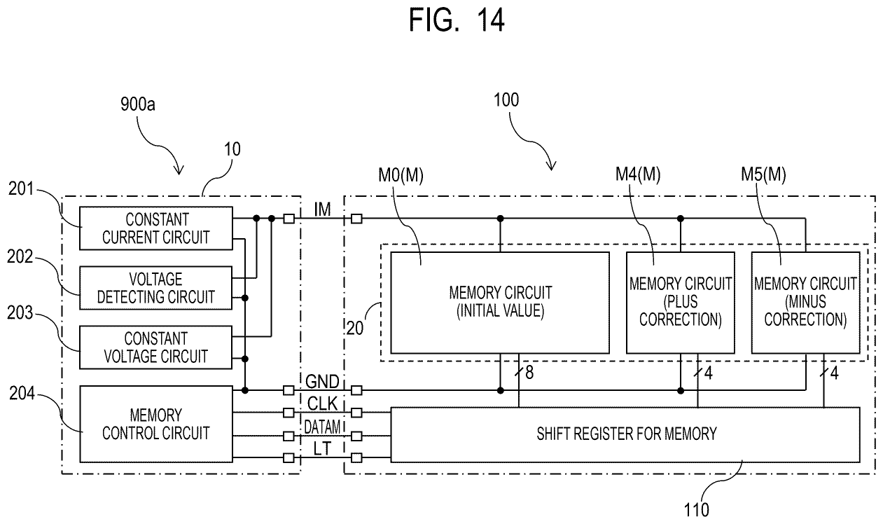

FIG. 14 is a schematic diagram for illustrating a configuration of the printing head 810 according to the fourth embodiment of the present disclosure. In FIG. 14, electrical connection between the main-body portion 900a of the printing apparatus 900 and the element substrate 100 of the printing head 810 is schematically illustrated. In FIG. 14, only portions related to the memory circuits are illustrated, and other elements are omitted.

The main-body portion 900a of the printing apparatus 900 includes the control unit 10. The control unit 10 includes the constant current circuit 201, the voltage detecting circuit 202, and the constant voltage circuit 203. Those circuits are basically the same as the ones described in the first embodiment. The memory control circuit 204, the heater control circuit 151, the heater power generating circuit 152, the driver driving power generating circuit 153, and the logic power circuit 154 are omitted.

The element substrate 100 includes the memory unit 20 and the shift register 110 for memory. The memory unit 20 includes the memory circuit (an initial value) M0, a memory circuit (plus correction) M4, and a memory circuit (minus correction) M5. The memory circuit M4 can be called a memory circuit for storing a correction value to be added to the fixed value (initial value) (also referred to as “plus-correction value memory circuit”). The memory circuit M5 can be called a memory circuit for storing a correction value to be subtracted from the fixed value (initial value) (also referred to as “minus-correction value memory circuit”). The memory circuit M0 and the shift register 110 for memory are basically the same as the ones described in the second embodiment. The heater circuit 101 and the shift register 102 for heater are omitted.

The memory circuit M0 stores the density rank. Also in this embodiment, the density rank is managed with rank values ranging from 0 to 31 as in the second embodiment, and the memory circuit M0 accordingly has a capacity of 5 bits. The memory circuit M4 stores a plus change amount (a plus correction value) of the density rank in reuse, and the memory circuit M5 stores a minus change amount (a minus correction value) of the density rank in reuse. The memory circuits M4 and M5 are configured so as to be used in common for every reuse. Specific description on the respective configurations is given below, with the initial rank value, the change amount in the first-time reuse, and the change amount in the second-time reuse set to “17,” “plus 2,” and “minus 1,”respectively.

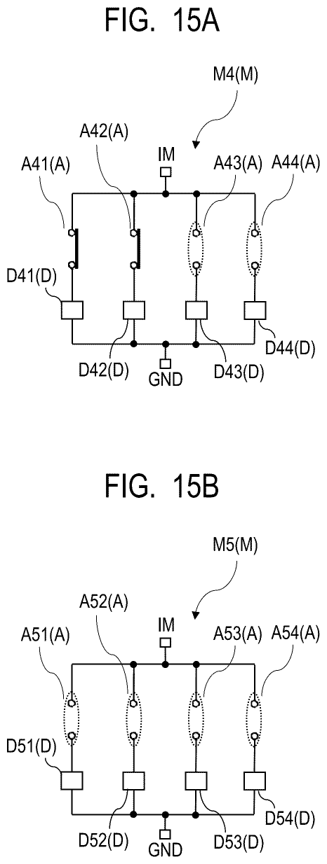

FIG. 15A and FIG. 15B are diagrams for illustrating configurations of the memory circuits M4 and M5. The memory circuit M4 includes four antifuse elements A41 to A44 connected in parallel, and is configured so as to be capable of storing 4 bits of data. Driver circuits D41 to D44 are connected to the antifuse elements A41 to A44, respectively. The antifuse elements A41 to A44 and the driver circuits D41 to D44 have the same structures as the structures of the antifuse elements A and the driver circuits D, respectively, of the memory circuit M0 described in the first embodiment.

This memory circuit M5 includes four antifuse elements A51 to A54 connected in parallel, and is configured so as to be capable of storing 4 bits of data. Driver circuits D51 to D54 are connected to the antifuse elements A51 to A54, respectively. The antifuse elements A51 to A54 and the driver circuits D51 to D54 have the same structures as the structures of the antifuse elements A and the driver circuits D, respectively, of the memory circuit M0 described in the first embodiment.

FIG. 15A is an illustration of a state of the memory circuit M4 in the first-time reuse, and FIG. 15B is an illustration of a state of the memory circuit M5 in the first-time reuse. In the first-time reuse, the rank value has changed by plus 2. Accordingly, in the memory circuit M4, the antifuse elements A41 and A42 are in a conductive state, and the antifuse elements A43 and A44 are in a non-conductive state. In the memory circuit M5, on the other hand, the antifuse elements A51 to A54 are all in a non-conductive state because the quantity by which the rank has changed is not a minus quantity.

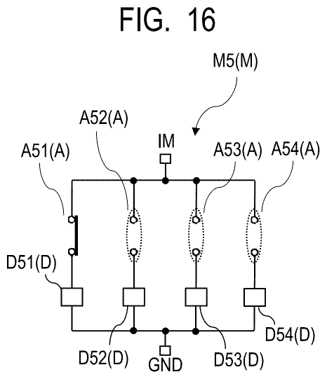

FIG. 16 is an illustration of the state of the memory circuit M5 in the second-time reuse. In the second-time reuse, the rank value has changed by minus 1. Accordingly, in the memory circuit M5, the antifuse element A11 is in a conductive state, and the antifuse elements A42 to A44 are in a non-conductive state. The memory circuit M4 in the second-time reuse is in the same state as in FIG. 15A.

Processing in which the printing apparatus 900 reads the states of the memory circuits M0, M4, and M5 to recognize the density rank value is described next. Here, the memory circuit M0 is in the state of FIG. 9, the memory circuit M4 is in the state of FIG. 15A, and the memory circuit M5 is in the state of FIG. 16.

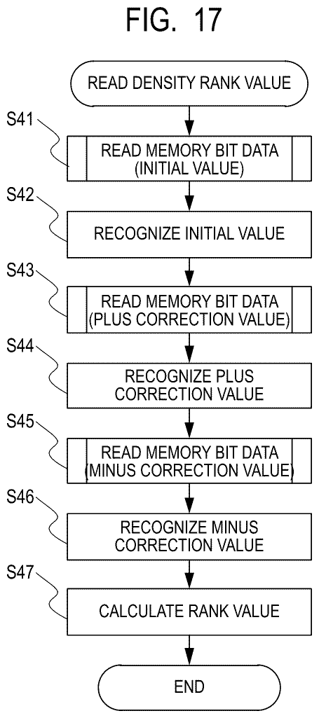

FIG. 17 is a flow chart of data recognition processing in which the control unit 10 of the printing apparatus 900 recognizes density rank values that are stored in the memory circuits M (M0, M4, and M5). A flow for memory bit data reading of Step S41, Step S43, and Step S45 in the flow chart of FIG. 17 is the same as the flow illustrated in FIG. 6B, and illustration and description thereof are accordingly omitted. Processing of recognizing the initial value of the rank in Step S42 is the same as in the first embodiment, and description thereof is accordingly omitted here.

Step S41 and Step S42 are the same as Step S1 and Step S2 illustrated in FIG. 6A. In Step S43, bit data stored in the memory circuit M4 is read. Processing of reading the data is as in the data read flow of FIG. 6B in which data of each bit of the memory is read. Four bits of data are read out of the memory circuit M4. At this point in the description, the printing head has been reused twice, and pieces of bit data are read out of the memory circuit M4 in the state illustrated in FIG. 15A.

Next, in Step S44, a plus correction value indicated by the pieces of bit data of the memory circuit M4 that have been read in Step S43 is recognized. That the antifuse elements A41 and A42 of the memory circuit M4 are in a conductive state, with the antifuse elements A43 and A44 being in a non-conductive state has been read in Step S43. Accordingly, a value by which the rank value is to be corrected on a plus side is recognized to be “2” in Step S44. Here, how many times the printing head has been reused is ignored, and what the correction value is at the time of reading is recognized.

Next, in Step S45, bit data stored in the memory circuit M5 is read. Processing of reading the data is as in the data read flow described with reference to FIG. 6B as a flow for reading data of each bit of the memory. Four bits of data are read out of the memory circuit M5. At this point in the description, the printing head has been reused twice, and pieces of bit data are read out of the memory circuit M5 in the state illustrated in FIG. 16.

Next, in Step S46, a minus correction value indicated by the pieces of bit data of the memory circuit M5 that have been read in Step S45 is recognized. That the antifuse element A51 of the memory circuit M5 is in a conductive state, with the antifuse elements A52 to A54 being in a non-conductive state has been read in Step S45. Accordingly, a value by which the rank value is to be corrected on a minus side is recognized to be “1” in Step S46.

Lastly, in Step S47, “18” obtained by totaling all of the initial rank value “17,” the plus-side correction value “2,” and the minus-side correction value “1” is recognized to be the latest density rank value. Totaling the minus-side correction value “1” means subtracting “1.” Step S41 and Step S42 can be called “fixed value recognition step.” Step S43 to Step S46 can be called “correction value recognition step.” Step S47 can be called “calculation step.”

As described above, according to the printing head 810 of this embodiment, the fixed value is updatable even when the fixed value is of a type that has a change amount in reuse which increases or decreases, and the latest fixed value of the printing head 810 can accordingly be recognized.

Also in the printing head 810 according to this embodiment, any of fuse elements and antifuse elements may be used to configure the memory circuits M0, M4, and M5. However, as described in the first embodiment, a memory circuit that uses antifuse elements is smaller in area than a memory circuit that uses fuse elements, and antifuse elements are accordingly preferred to be used.

According to the present disclosure, it is possible to update a fixed value and, at the same time, prevent memory capacity and head size from increasing.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-176464, filed Oct. 8, 2024, which is hereby incorporated by reference herein in its entirety.

What is claimed is:

1. A printing head comprising a memory unit configured with use of one of fuse elements or antifuse elements, the memory unit including:
a main memory circuit configured to store a fixed value related to the printing head; and
at least one correction value memory circuit configured to store a correction value for updating the fixed value.

2. The printing head according to claim 1, wherein the correction value is a change amount from the fixed value prior to an update to the fixed value after the update.

3. The printing head according to claim 2, wherein the correction value is stored in the at least one correction value memory circuit when the printing head is reused.

4. The printing head according to claim 3, wherein the at least one correction value memory circuit includes a number of correction value memory circuits equal to a number of times the printing head is reused.

5. The printing head according to claim 4, wherein a capacity of the correction value memory circuit for each reuse is smaller than a capacity of the main memory circuit.

6. The printing head according to claim 4, wherein the at least one correction value memory circuit includes a plurality of bits, and one bit out of the plurality of bits indicates whether the correction value is to be added to the fixed value or to be subtracted from the fixed value.

7. The printing head according to claim 3, wherein the at least one correction value memory circuit includes a correction value memory circuit used in common for a plurality of times the printing head is reused.

8. The printing head according to claim 3, wherein the at least one correction value memory circuit includes a memory circuit configured to store a correction value to be added to the fixed value, and a memory circuit configured to store a correction value to be subtracted from the fixed value.

9. The printing head according to claim 1, wherein the fixed value is a value related to a drive pulse width for driving the printing head.

10. The printing head according to claim 1, wherein the fixed value is a value related to a density of a printed material printed with use of the printing head.

11. A data recognition method for recognizing data of a printing head which includes a memory unit configured with use of one of fuse elements or antifuse elements, the memory unit storing, as bit data, a fixed value related to the printing head and a correction value for updating the fixed value, the data recognition method comprising:
a fixed value recognition step of recognizing the fixed value by reading the bit data of the fixed value out of the memory unit;
a correction value recognition step of recognizing the correction value by reading the bit data of the correction value out of the memory unit; and
a calculation step of calculating a latest fixed value based on the fixed value recognized in the fixed value recognition step, and on the correction value recognized in the correction value recognition step.

12. The data recognition method according to claim 11,
wherein the memory unit includes a number of correction value memory circuits equal to a number of times the printing head is reused, and the correction value for each reuse is stored as bit data in a corresponding correction value memory circuit for the reuse, and
wherein the correction value recognition step includes reading bit data out of the corresponding correction value memory circuit for each reuse to recognize the correction value for the each reuse.

13. The data recognition method according to claim 11,
wherein the memory unit includes a correction value memory circuit that includes a plurality of bits, one bit out of the plurality of bits represents a sign indicating whether the correction value is to be added to the fixed value or to be subtracted from the fixed value, and remaining bits store the correction value, and
wherein the correction value recognition step includes recognizing the correction value and the sign by reading the bit data out of the correction value memory circuit.

14. The data recognition method according to claim 11,
wherein the memory unit includes a memory circuit configured to store, as bit data, a plus correction value to be added to the fixed value, and a memory circuit configured to store, as bit data, a minus correction value to be subtracted from the fixed value, and
wherein the correction value recognition step includes recognizing the plus correction value by reading the bit data out of the memory circuit configured to store the plus correction value, and recognizing the minus correction value by reading the bit data out of the memory circuit configured to store the minus correction value.
